(19) United States
(12) Patent Application Publication
(10) Pub. No.: US 2006/0075215 A1
(43) Pub. Date: Apr. 6, 2006

(54) Configurable BIOS strings

(75) Inventors: Lawrence Rawe, Colorado Springs, CO (US); Roy Wade, Colorado Springs, CO (US); Samantha Ranaweera, Colorado Springs, CO (US)

Correspondence Address: LSI LOGIC CORPORATION, 1621 BARBER LANE, MS: D-106, MILPITAS, CA, 95035, US

(73) Assignee: LSI Logic Corporation, Milpitas, CA (US)

(21) Appl. No.: 10/949,578

(22) Filed: Sep. 25, 2004

(51) Int. Cl. G06F 9/24; G06F 17/20; G06F 17/24

(52) U.S. Cl. 713/2; 704/8; 715/531

(57) ABSTRACT

A system and method for deploying various versions of a BIOS system having configurable text strings. When a text string is required, the BIOS or configuration tool may retrieve a text string from the text string location. The executable BIOS and configuration tool may be common for many applications while the text strings may be changed for various applications. The text strings may be customized for various languages or applications without requiring recompiling the BIOS or configuration tool executable code.

### BACKGROUND OF THE INVENTION

a. Field of the Invention

The present invention pertains generally to computing devices and specifically to programs executed during the bootstrap phase of operation.

b. Description of the Background

The Basic Input/Output System (BIOS) software is a program that is loaded by a computer during initial startup. The BIOS is a very low level program that establishes the basic interfaces for the computer processor and enables the processor to bootstrap an operating system. After an operating system is running, application programs may be loaded and run.

A BIOS program may perform various startup and initialization functions using a configuration setting. For example, devices such as hard disk drives, input devices, or other devices may be configured during BIOS execution so that the computer system may start up in a specific sequence with specific functionality. Such settings may be stored in nonvolatile memory.

A BIOS configuration program may be used to change the settings used by the BIOS. The configuration program is sometimes stored in the same nonvolatile memory as the BIOS itself. Typically, the configuration program is compiled and run in the same environment as the BIOS.

A BIOS program may have some error messages or status messages that are displayed during execution. These messages are typically textual messages.

Often different versions of the BIOS are needed that do not affect the underlying functions of the BIOS or configuration program. For example, deploying the BIOS in English or Italian may require two different BIOS versions where each version performs the same function, but the differences lie in the text messages.

It would therefore be advantageous to provide a system and method whereby a BIOS and a BIOS configuration tool may be deployed using different text messages in a simple, economical manner.

### SUMMARY OF THE INVENTION

The present invention overcomes the disadvantages and limitations of previous solutions by providing a system and method for deploying various versions of a BIOS system having configurable text strings. When a text string is required, the BIOS or configuration tool may retrieve a text string from a text string image. The executable BIOS and configuration tool may be common for many applications while the text strings may be changed for various applications.

An embodiment of the present invention may therefore include a method comprising: selecting a first text image file; executing an executable program image as the first executable instructions when starting a computer processor; within the executable program, determining that a first text message is to be displayed; locating a first text string within the first text image by referencing a first index in the first text image; displaying the first text string on a display as the first message; selecting a second text image file; executing the executable program image as the first executable instructions when starting the computer processor; within the executable program, determining that the first text message is to be displayed; locating a second text string within the second text image by referencing the first index in the second text image; and displaying the second text string on a display as the first message.

Another embodiment of the present invention may include a method comprising: executing an executable program image as the first executable instructions when starting a computer processor; within the executable program, determining that a first text string is to be displayed; locating the first text string within a first text image by referencing a first index in the first text image; and displaying the first text string on a display.

Yet another embodiment of the present invention may include a system comprising: a first text image comprising a first index and a first text string; a second text image comprising a second index and a second text string; and an executable image capable of being the first executable image processed by a processor during startup, the executable image having at least one displayable message and being adapted to use either the first text string or the second text string for the message, depending on whether the first text image or the second text image is present during execution of the executable image.

The advantages of the present invention are that a single executable version of a BIOS or BIOS configuration tool may be used for many different applications such as multiple languages or various customized applications. A single executable BIOS or configuration tool reduces manufacturing complexities such as version control, testing, updating, and maintenance. Further, the text strings may be customized by OEMs for their particular application without requiring compiling and testing a new version of the BIOS or configuration tool.

### BRIEF DESCRIPTION OF THE DRAWINGS

In the drawings,

FIG. 1 is a diagrammatic illustration of an embodiment showing a system using a BIOS with a text image.

FIG. 2 is a workflow diagram illustration of an embodiment showing the interrelationships of a system using a text image.

FIG. 3 is a diagrammatic illustration of an embodiment showing a text string image file.

FIG. 4 is a flowchart illustration of an embodiment showing a method for using a text image file.

### DETAILED DESCRIPTION OF THE INVENTION

While the invention is susceptible to various modifications and alternative forms, specific embodiments thereof are shown by way of example in the drawings and will be described in detail herein. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify the elements throughout the description of the figures. It will also be understood that when an element is referred to as being “connected” or “coupled” to another element, it can be directly connected or coupled to the other element or intervening elements may also be present. In contrast, when an element is referred to as being “directly connected” or “directly coupled” to another element, there are no intervening elements present.

The present invention may be embodied as devices, systems, methods, and/or computer program products. Accordingly, the present invention may be embodied in hardware and/or in software (including firmware, resident software, micro-code, etc.) Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), an erasable programmable read-only memory (EPROM or Flash memory), an optical fiber, a portable compact disc read only memory (CD-ROM), and a digital video disk read only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

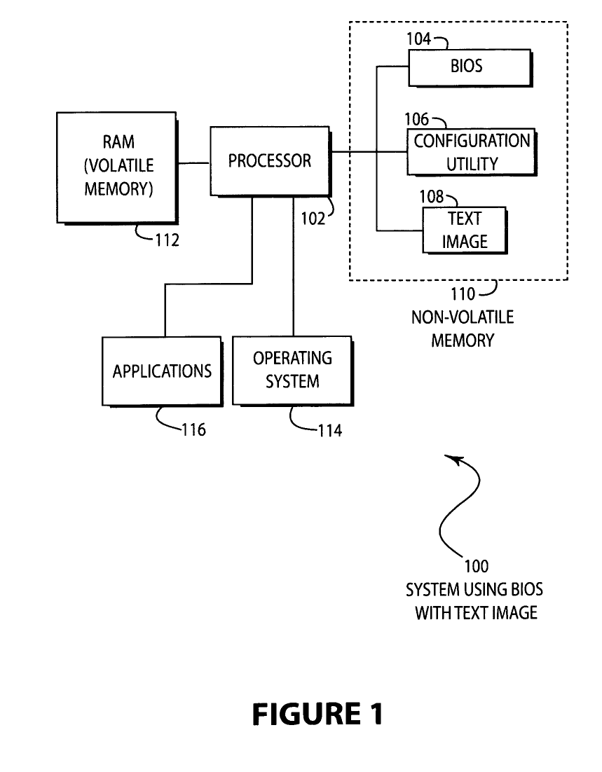

FIG. 1 illustrates an embodiment 100 of the present invention showing a system using a BIOS with a text image. A processor 102 uses a BIOS 104, configuration utility 106, and text image 108 that reside in nonvolatile memory 110. The processor 102 also has access to an operating system 114 and various applications 116, both of which are typically loaded into volatile random access memory (RAM) 112.

The BIOS 104 is typically the first program executed by the processor 102 during start up. The BIOS 104, known as the Basic Input/Output System, establishes the lowest level configuration of the overall system, such as the characteristics of the various devices attached to the processor 102 and other settings required for higher level programs to operate properly. After the BIOS 104 successfully runs, the operating system 114 is loaded into RAM 112 and executed. The process of running the BIOS and loading the operating system is commonly known as bootstrapping. The operating system 114 in turn calls various applications 116 to perform the required tasks of the overall system. In some embodiments, the BIOS 104 may be known as an Extensible Firmware Interface Boot Services Driver, an SRM console, an FCODE module, or a shell application. For the purposes of this application, the term BIOS shall refer to the machine executable code executed during the startup and bootstrapping of a processor.

The BIOS 104 is generally machine executable code specific to the processor 102. The processor 102 may have a hard coded procedure that looks to a specific address to start executing a program. Typically, that program may be a system ROM BIOS. Other programs commonly known as option ROM BIOS may also be called to perform various functions. These BIOSes 104 is generally located in a nonvolatile memory 110 such as a ROM, EEPROM, programmable gate array, flash memory, or other nonvolatile memory.

The configuration utility 106 is typically executed by branching out of the BIOS 104 program and can be used to set the various parameters executed by the BIOS 104. In some applications, a specific keystroke may be entered during the BIOS 104 execution to start the configuration utility 106. In many applications, the configuration utility 106 may display various messages on a display, such as the current settings of the BIOS 104 and alternative selections for the operator to choose.

Similarly, the BIOS 104 may display various status messages during normal execution. For example, some BIOS 104 programs display a manufacturer's name, version number, memory size, and other parameters and messages.

The BIOS 104 and configuration utility 106 may operate with different text images 108 for various applications. For example, a version of the text image 108 may be created in English while others may be created in Italian, Swedish, or any other language. By changing only the text image 108 to change from one language to another, the BIOS 104 and configuration utility 106 do not need to change.

In many OEM applications, a single manufacturer may supply a BIOS 104 that is used by several different OEM vendors. These vendors may elect to have specific text messages displayed when the BIOS 104 or configuration utility 106 are executed.

Because the BIOS 104 and configuration utility 106 do not change for different language applications, the functionality of the BIOS 104 and configuration utility 106 can be tested and certified for all languages, vendors, or other applications without having to recreate the BIOS 104 and configuration utility 106 for multiple applications.

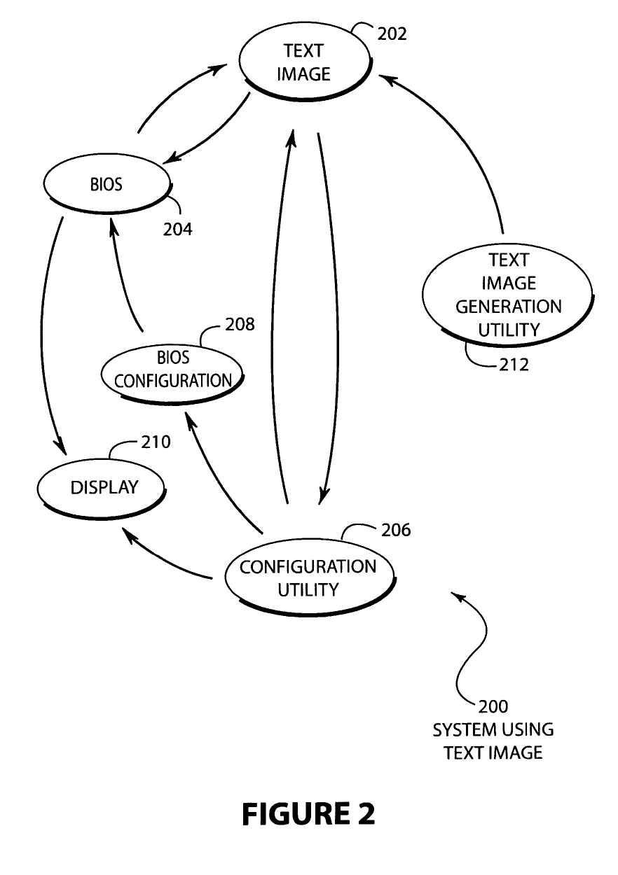

FIG. 2 illustrates an embodiment 200 of the interactions between several software components of the present invention. A text image 202 interacts with the BIOS 204 and configuration utility 206, each of which place text on a display 210. The configuration utility 206 is used to define the BIOS configuration 208. A text image generation utility 212 is used to create the text image 202.

In some applications, several instances of a text image 202 will be created. A different text image 202 will be created for each language in which the BIOS 204 and configuration utility 206 will operate. Additionally, various OEM manufacturers may customize the text image 202 to suit their particular purposes. Similarly, text image instances may be created for specialized applications where a certain set of text displays are required.

Both the BIOS 204 and the configuration utility 206 may be executable images executed by a processor during the initial startup or bootstrapping process. Similarly, the text image 202 may be a low level machine readable image containing the specific text strings that may be displayed at various points during the execution of the BIOS 204 or configuration utility 206.

Typically, the configuration utility 206 may be launched by some signal given while the BIOS 204 is running. The configuration utility 206 may have an interactive menu or display that allows a user to set certain parameters that will be stored in the BIOS configuration 208.

The configuration utility 206 may use the same text image 202 as the BIOS 204, or separate text images may be used. A benefit to using the same text image 202 is that only one image needs to be maintained for several different applications. In an embodiment with two text images, the image used by the configuration utility 206 may have local language customizations whereas the text image used by the BIOS 204 may be a commonly spoken language such as English.

The text image generation utility 212 may be an application that is adapted to generate a text image 202. Such an application may run as a normal application on a computer system with an operating system. In some cases, the utility 212 may have a graphical user interface. The utility 212 may take several text strings and create a machine readable image in a format so that the BIOS 204 or configuration utility 206 may find the proper text string and display the string.

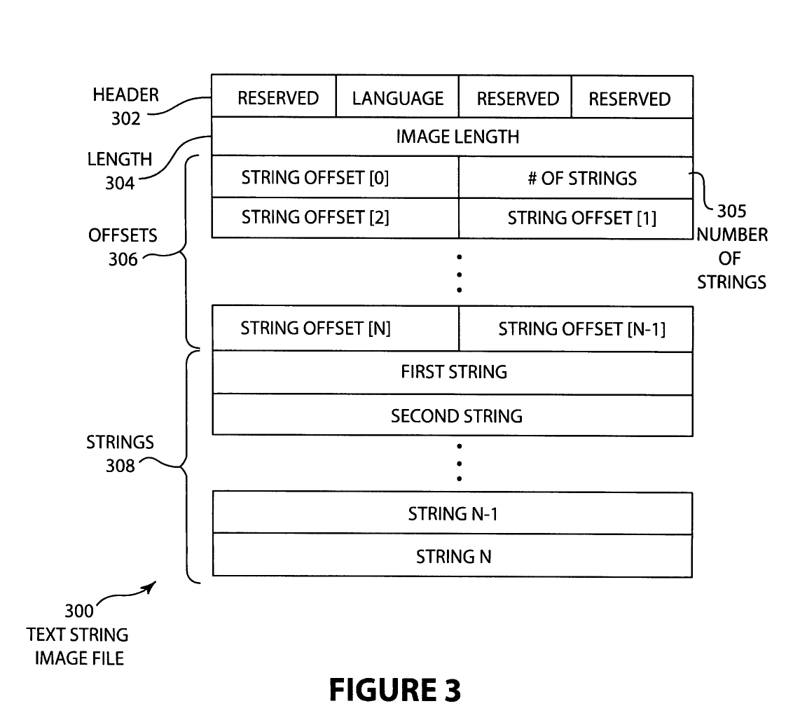

FIG. 3 illustrates an embodiment 300 of a text string image file. The embodiment 300 comprises a header 302, an image length 304, the number of strings 305, string offsets 306, and the strings 308.

The embodiment 300 is merely one of an infinite number of variations for the structure of a text image useful to be read by a BIOS or configuration utility.

The header 302 may contain top level information that may be used to identify the particular text image. For example, the language of the strings, version number, release date, or any other useful information may be contained in the header. In some embodiments, the number of bytes allocated to the header may be fixed for various instances of the text image.

The image length 304 may refer to the size of the text image 300. The image length may be used for checking that any addresses of strings inside the text image 300 are valid, or for other functions such as verifying that the image as a whole is valid.

The number of strings 305 indicates the number of entries in the text image 300.

The string offsets 306 indicate an address for each of the strings 308. Each string offset 306 may point to a starting character of a text string 308. In the embodiment 300, the header 302, length 304, and number of strings 305 may be a fixed number of characters for each instance of a text image 300. Thus, the program using the text image may know the starting address of the text image 300 and be able to calculate the location of the desired string offset 306. For example, in order to find the third string from the text image, the header length plus three times the size of the string offset could be used to point to the address for the third string.

The strings 308 may each be a different length. Some strings may be a single character while others may be hundreds of characters long. Further, a text image for one language or application may use a certain length string while a text image for another language or application may use a different length string.

There are several ways for the BIOS or configuration utility to determine the proper size of the string. In one embodiment, the strings 308 may be terminated with a null character. In such an embodiment, the program reading the text image will retrieve the string offset for the specific text string, point to the beginning character of that text string, and read until a null character is encountered. A null character is not the only character that can be used to signal the end of a string, since any predetermined terminating character could be used.

In another embodiment, a program may read the string offset of the desired text string and also read the next string offset in sequence. The program may then begin reading at the first string offset and read until the second string offset is reached. In some embodiments, the string offsets 306 may include a beginning pointer and an ending pointer for each string. Various methods and constructions may be used while keeping within the spirit and intent of the present invention.

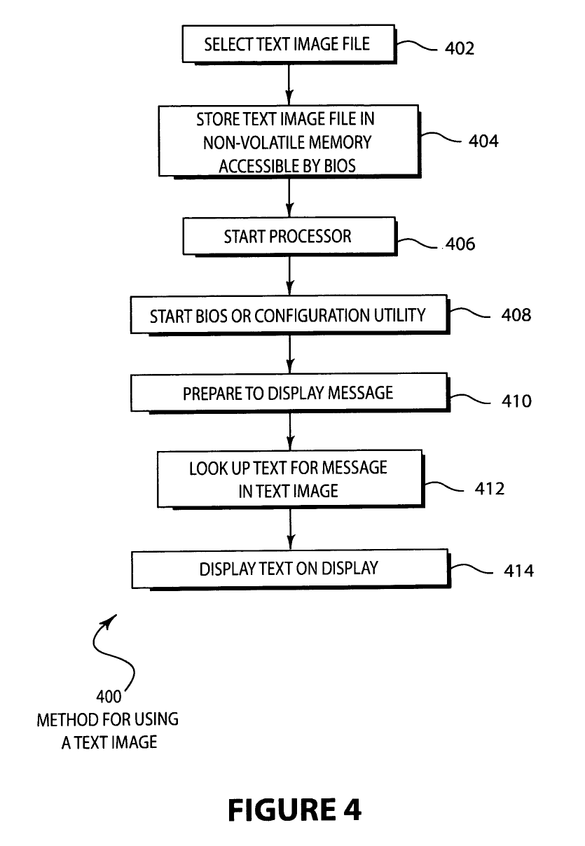

FIG. 4 illustrates an embodiment 400 of a method for using a text image file by a BIOS or configuration utility. The text image is selected in block 402 and stored in nonvolatile memory in block 404. The processor is started in block 406, which calls the BIOS or configuration utility in block 408. The executing program determines that a message is to be displayed in block 410, looks up the text for the message from the text image in block 412 and displays the text in block 414.

The embodiment 400 may be used for several different text images. For example a text image for English language applications may be used. Then, a text image for a Finnish language application may be substituted in the nonvolatile memory and Finnish language text messages would be displayed. In both instances, the BIOS and configuration utility would be the same executable image, but used for two different language applications.

Similarly, different text images may be used by different OEM manufacturers. Each OEM manufacturer may create or modify the text image for their specific application. However, the BIOS and configuration utility executable image could be the same. The vendor that produces the BIOS and configuration utility may only need to build, test, and distribute one version of the executable code for many different applications. Such a system may reduce the complexity and therefore costs of the vendor.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method comprising:
selecting a first text image file;
executing an executable program image as the first executable instructions when starting a computer processor;
within said executable program, determining that a first text message is to be displayed;
locating a first text string within said first text image by referencing a first index in said first text image;
displaying said first text string on a display as said first message;
selecting a second text image file;
executing said executable program image as said first executable instructions when starting said computer processor;
within said executable program, determining that said first text message is to be displayed;
locating a second text string within said second text image by referencing said first index in said second text image; and
displaying said second text string on a display as said first message.

2. The method of claim 1 wherein said first text image comprises text in a first language and said second text image comprises text in a second language.

3. The method of claim 1 wherein said first index comprises a starting pointer.

4. The method of claim 3 wherein said first index further comprises an ending pointer.

5. The method of claim 1 wherein said first text image comprises an end of string character.

6. The method of claim 5 wherein said end of string character is a null character.

7. The method of claim 1 wherein said executable program comprises a basic input/output system.

8. A method comprising:
executing an executable program image as the first executable instructions when starting a computer processor;
within said executable program, determining that a first text string is to be displayed;
locating said first text string within a first text image by referencing a first index in said first text image; and
displaying said first text string on a display.

9. The method of claim 8 wherein said first index comprises a starting pointer for said first text image.

10. The method of claim 9 wherein said first index further comprises an ending pointer for said first text image.

11. The method of claim 8 wherein said first text image comprises an end of string character.

12. The method of claim 11 wherein said end of string character is a null character.

13. The method of claim 8 wherein said executable program comprises a basic input/output system.

14. The method of claim 8 further comprising:
executing a configuration utility for said executable program;
within said configuration utility, determining that a second text string is to be displayed;
locating said second text string within a second text image by referencing a second index in said second text image; and
displaying said second text string on said display.

15. A system comprising:
a first text image comprising a first index and a first text string;
a second text image comprising a second index and a second text string, said first index and said second index being located in the same relative place in said first text image and said second text image, respectively; and
an executable image capable of being the first executable image processed by a processor during startup, said executable image having at least one displayable message and being adapted to use either said first text string or said second text string for said message, depending on whether said first text image or said second text image is present during execution of said executable image.

16. The system of claim 15 further comprising a configuration utility capable of changing at least one parameter used by said executable image, said configuration utility being adapted to use either said first text string or said second text string for said message, depending on whether said first text image or said second text image is present during execution of said configuration utility.

17. The system of claim 16 wherein said first text image comprises text in a first language and said second text image comprises text in a second language.

18. The system of claim 16 wherein said first index comprises a starting pointer.

19. The system of claim 18 wherein said first index further comprises an ending pointer.

20. The system of claim 16 wherein said first text image comprises an end of string character.

21. The system of claim 20 wherein said end of string character is a null character.

22. The system of claim 16 wherein said executable image comprises a basic input/output system.

23. The system of claim 16 further comprising:
a text generation utility adapted to receive a plurality of text strings, generate an index, and write a text image comprised of said text strings and said index.
